(19) United States
(12) Patent Application Publication
(10) Pub. No.: US 2009/0171914 A1
(43) Pub. Date: Jul. 2, 2009

(54) Systems and methods for aiding location of video files over a network

(75) Inventors: Harold S. Montgomery, Milwaukee, WI (US); Seth Ashby, Oakland, CA (US); Mathew DeBow, Orinda, CA (US); Christopher J. MacDonald, Brisbane, CA (US); Thomas S. Litchfield, Brentwood, CA (US)

Correspondence Address: RYAN KROMHOLZ & MANION, S.C., POST OFFICE BOX 26618, MILWAUKEE, WI, 53226, US

(73) Assignee: Media Syndication, Inc.

(21) Appl. No.: 12/231,364

(22) Filed: Sep. 2, 2008

Related U.S. Application Data
(60) Provisional application No. 60/966,879, filed on Aug. 30, 2007.

(51) Int. Cl. G06F 17/30

(52) U.S. Cl. 707/3; 707/104.1; 707/E17.009; 707/E17.108

(57) ABSTRACT

Systems and methods according to the present invention provide improved location of files over a network. More specifically, according to the present invention, a method of indexing digital video files on a content management system running on a web server includes associating a descriptive domain name with a dedicated node on the system, on which a single video is provided. Thus, each video is provided with a dedicated webpage, on which associated items, such as community feedback and attributes, may be displayed.

### RELATED APPLICATIONS

This application claims the benefit of co-pending U.S. Provisional Patent Application Ser. No. 60/966,879, filed 30 Aug. 2007.

### BACKGROUND OF THE INVENTION

The present invention pertains to online and Internet aggregation and distribution of digital film and video files, and specifically addresses the challenges relating to locating specific video content files in the Internet via search engine results.

Digital video viewing and distribution over the Internet has seen annual increases in usage throughout the history of the World Wide Web. However, finding specific video clips and full-length video title files through search engines has remained an imperfect process and has been hampered by obstacles. Such obstacles include the criteria limitations of software algorithms employed by search leaders such those of GOOGLE®, YAHOO!® and MICROSOFT® to rank content, and by a lack of software association between individual video files stored within large web sites to domain names that logically reflect the nature of the content of each file.

Several standards-based methods have been employed to address the challenges confronting video file search optimization including “tags” or language-based descriptors added to files and the inclusion of close captioning information within the individual file.

However, these solutions do not provide video content owners with search results identifying specific video files as individual web sites. Rather, they index each file as a subset of a broader domain name which may not accurately describe the specific video content.

### SUMMARY OF THE INVENTION

The present invention seeks to resolve these difficulties by providing a method and system for locating and viewing specific video files on the Internet as individual web sites, each with a unique Universal Resource Locator (URL) managed within a web-based Content Management System (CMS).

The system of the present invention allows an individual video file to be associated with a specific domain name. The domain name is preferably composed of specific related keywords which reflect the video's specific content. The domain names are then resolved to the file server or link location of each video. This is accomplished via the use of, for example, an open source software Content Management System (CMS) in cooperation with some modified definitional settings, as described below.

A specific domain name is placed, through the software, on each specific software node of the CMS containing an individual digital video file. As search engines crawl the web evaluating content by algorithm criterion, the domain name and node are indexed together with highly accurate content descriptions decipherable to both semantic machine-based search results and the human decision-making capability of individual users.

The system provides for concurrent human and mechanized evaluation of the content, increasing the likelihood that a search engine user may find accurate video clips relating to entered criteria without the use and expense of paid search results advertising.

The present invention includes an online Content Delivery Network (CDN) having proprietary software development of both a Content Management System (CMS) and a Content Tracker Database. These software and hardware components form the basis for a turnkey system capable of automating the processing, storage, delivery, promotion and sale of specific film and video files in digital format.

The present system may be implemented using common CMS and CDN offerings, both open Source and proprietary, including those distributed under the BRIGHTCOVE®, NUKE™, JOOMLA!®, THE PLATFORM®, MAMBO® trademarks, among others.

### BRIEF DESCRIPTION OF THE DRAWINGS

FIG. 1 is a diagrammatic system view including a system according to the present invention.

FIG. 2 is a flow chart illustrating the process by which the user may find the named nodes and associated video content.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

The system and process of the present invention is described herein utilizing the preferred CMS marketed under the DRUPAL® trademark, it is to be understood that the process may be practiced utilizing other CMS's or other languages such as those provided by JOOMLA®. DRUPAL® is a content management framework, CMS and blogging engine which was originally written by Dries Buytaert and is the software used to distribute content for a variety of entities. The DRUPAL® product is written in the PHP scripting language.

Normally, a URL is associated with a web site, which may or may not contain video. The present invention is directed to a URL that is permanently and directly linked to a CMS node that contains a video file. Linking of a URL to a CMS node in this fashion is believed to result in higher ranking on a search engine. The present invention is further directed to a method. As used generally herein, a URL pertains to a string including alphanumeric characters, and perhaps some punctuation, that is correlated or mapped to a numeric Internet Protocol (IP) address. That is, generally, a URL allows a user type in text, such as surfjawsmaui.com, and be directed to the mapped IP address.

To begin the process of the present invention, several preliminary steps must be completed. First, an appropriate domain name, such as a domain name comprising a plurality of concatenated words, such as a three (3) keyword combination uniquely describing the content of the video file, is chosen and requested to be registered. By way of example, the domain SurfjawsMaui.com is an appropriate three (3) keyword domain name. The example describes a video file having content on the sport of surfing at the surf spot Jaws located on the island of Maui. Once chosen, the specific domain name is then requested to be registered by an official Internet Registrar such as REGISTER.COM®, by way of non-limiting example.

Next, an appropriate open source software Content Management System (CMS) may be licensed via a General Public License (GPL) agreement, for example, and configured with some preferred additional software code, described below, added. The CMS is typically installed on an account at an Internet Service Provider (ISP) offering domain management services including domain rerouting to independent nodes. An example of such an ISP is that of SITEGROUND®.

The domain name is then resolved by a domain name server (DNS) to a specific node location within the CMS which has been set up to contain the specific video content file.

As previously mentioned, the process as is modeled and described herein, utilizes the preferred CMS, DRUPAL® 4.7.2, however it is to be understood that the process may be replicated using other CMS's or other languages, such as JOOMLA®.

Once all preliminary requirements are complete the following steps are followed using DRUPAL® CMS:
1. Go to the CMS administration module, in this case and the example as follows is for DRUPAL® 4.7.2
2. In the “Sites” directory create a folder with the appropriate domain name—i.e. surfjawsmaui.com
3. Configure the ISP to accept the domain as a “parked domain” so that it resolves to the main DRUPAL® installation.
4. Configure the “settings.php” software code file to point to the particular node that has the content that is relevant to the domain in question. A node as used in the present context refers to the location within the Content Management System that holds the video file location for download and other items related to the video content such as descriptive text, images, as well as user comments, ratings and other community based features as they become available. For example, a node may be a single piece of content that is published on a site, such as a blog post, forum topic, or single image. The following code may be used to configure, for example, a “settings.php” file to be used in connection with the main DRUPAL installation for the chosen domain, (surfjawsmaui.com):

$conf = array(

‘site_name’ => ‘surfjawsmaui.com’,
‘theme_default’ => ‘theme_name’,
‘site_frontpage’ => ‘node/x’

),

where x is the number of the node associated with the video content to be available when the IP address associated with the domain is accessed.

The theme can be controlled by the “theme_name.” A theme, or template, is generally understood in the art of web design, and usually comprises definitions for the arrangement of items to be displayed, such as those discussed in connection with the node window 40, below. Such definitions may include syntactically correct definitions for background color, font, layout, etc.

Upon the modifications of the settings.php file and association of the file with the main DRUPAL installation, the domain (surfjawsmaui.com) will resolve to the associated node (x) using the desired theme (theme_name).

Also, the following assignment or definition may be added to the array $conf as defined above:

‘anonymous’=>‘Visitor’

Such addition to the array would allow all visitors to the domain to view content. Alternatively, if it is desirable to allow subscription service, such permissions may be removed, and a login screen may be rendered and displayed.

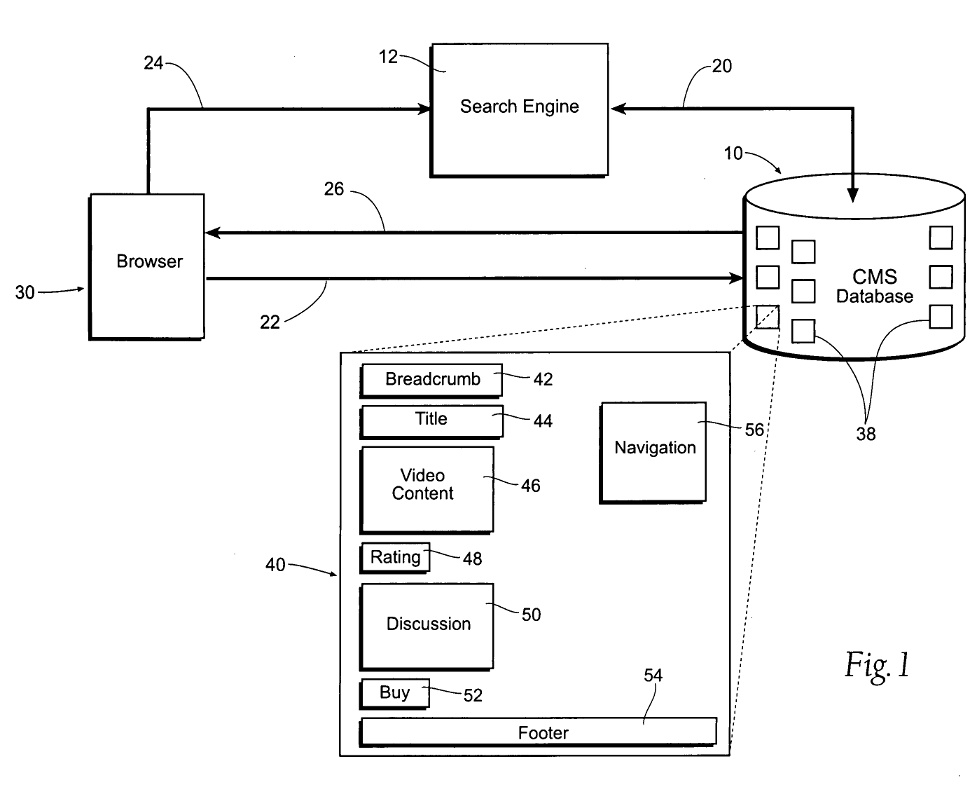

Each CMS stores information in a database, which, when called on, transmits the results to a user's web browser for display to the user. The system according to this process may be viewed in the diagram depicted in FIG. 1. As seen at reference numeral 10, a search engine 12 crawler indexes and ranks the CMS 10 initially, then periodically returns to update this ranking 20. A selected user uses an Internet browser 30 to send a request 22 to the CMS 10, the request 22 having perhaps been influenced by the ranking of the domain name by the search engine 12. The CMS database 10 responds 26 with a rendered node window 40 associated with the proper node 38. The request 22, which is usually sent after a search request 24 is sent from a browser 30 to a search engine 12, prompts the CMS 10 to dynamically retrieve from the CMS database 10 software, graphics, video and text to be displayed in the rendered node window 40. The request 22 may be sent directly to the CMS database 10, as shown, or may be redirected through the search engine 12, such as by selecting a search result displayed thereby.

The rendered node window 40 includes information to be displayed. In the example illustrated in FIG. 1, the information displayed includes content titles 44, the video content 46, navigation 56, and images 46. This is viewed within the node window 40 which is rendered and sent 26 to the user's browser 30. The information displayed in the node window 40 may include further information such as, but are not limited to, text descriptions and graphics. As is further illustrated, the breadcrumb 42 preferably comprises a menu link system showing the hierarchical structure of CMS categories, such as related types of video files. Other information shown in FIG. 1 includes the title 44 of the file displayed, and the video content 46, which is the video file as played back by the CMS 10. Furthermore, and as available using the DRUPAL® system, the node window 40 may also include the DRUPAL® rating system software 48 which allows users to rate each video file, and the DRUPAL® discussion window 50 to allow users to comment on the video file. Additionally, the DRUPAL® buy button 52 may be included to allow users to purchase a copy of the video file. When desired, a footer 54 may be included to display various information, such as legal information. Further, a dialog box may appear when a user clicks on a video file to playback or download the file, where the file is protected by a rights management system such as Windows Media Protection (WMP). A navigation system 56 may be provided to allow user access to all menus.

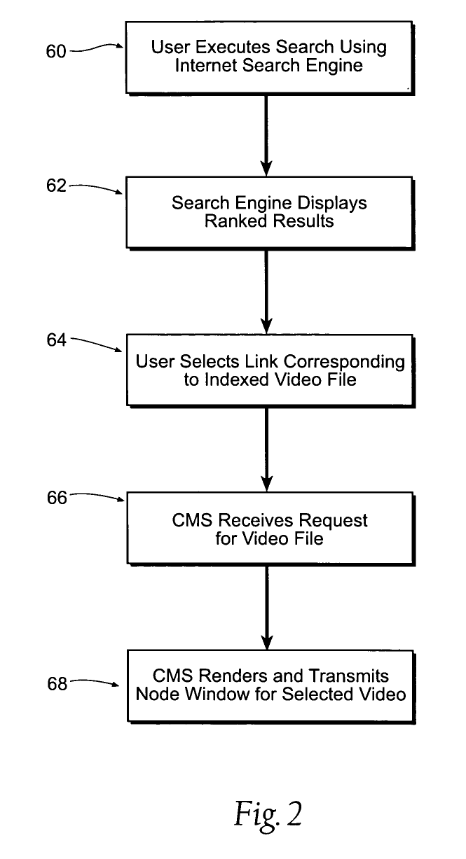

Once the domain is resolved to the correct node 38 it will be indexed automatically by search engine algorithms including the GOOGLE®, YAHOO®, and MICROSOFT® search engines, among others. The recognition of such resolution may take several days for any newly registered domain name. Following indexing, the domain-named nodes 38 and associated video content may be found by users. FIG. 2 illustrates an example of this process. As seen, a user has access to the Internet, accesses a search engine, and enters a search request or search term 60 relating to a movie or video file desired. An example of such a request is “Maui Surfing at Jaws Video.” In response to the search request 60, the search engine displays 62 a list of search results. The semantic use of a descriptive domain name is believed to improve the search engine's ranking of the resolved domain name and, consequently, the CMS node 38. A link to the node 38 containing the video file associated with the domain is displayed 62 as search engine results. Next, the CMS resolves the specific video file to its specific URL domain address located at the CMS node 38, and a node window 40 is rendered and transmitted 68 to the user where the video file is available for viewing or download by the user.

The invention also has the benefit of providing an individual video file a “permanent home” on the Web, and can generate community around that home, as is known to those familiar with community based web design using, for example, Web 2.0. The mechanism by which community, in the form of rating, commenting and sharing the video file, is generated around a video file is thought to be novel. Furthermore, the specific collection of node window 40 elements including breadcrumb 42, title 44 (with appropriate header tagging, content discussion, rating, discussion, and meta), video content playback 46, a buy button 52, footer 54 and navigation 56 is believed to improve search engine ranking.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A method of indexing a specific video file on a computer network, the method comprising:
indexing said specific video file on a dedicated node within a content management system database;
providing a domain name; and
correlating said specific video file with said domain name.

2. The method of claim 1, further comprising the step of resolving said domain name to said dedicated node.

3. The method of claim 2, further comprising the step of receiving a user request to transmit the video content file over the network.

4. The method of claim 3, further comprising the step of transmitting the video over the network in response to the user request.

5. The method of claim 1, wherein said domain name comprises a concatenation of a plurality of words.

6. The method of claim 5, wherein each of said plurality of words is at least partially descriptive of images included in said specific video file.

7. The method of claim 5, wherein said domain name comprises a concatenation of three words.

8. The method of claim 1, wherein said domain name is at least partially descriptive of images included in said specific video file.

9. The method of claim 1, further comprising the steps of:
accessing an administration module of said content management system database;
configuring said domain name as a parked domain; and
mapping said parked domain to said dedicated node on said content management system.

10. The method of claim 9, wherein the mapping step comprises the steps of:
providing a settings.php file related to said content management system; and
configuring said settings.php file to map said domain name to said dedicated node.

11. The method of claim 10, wherein the configuring said settings.php file step comprises the step of defining a PHP array as follows:
$conf = array(
‘site_name’ => ‘SITE NAME’,
‘theme_default’ => ‘THEME’,
‘site_frontpage’ => ‘node/X’
)
wherein SITE NAME is said domain name, THEME is a definitional template, and X is a node reference automatically generated by said content management system.

12. The method of claim 10, wherein the configuring said settings.php file step comprises the step of defining a PHP array as follows:
$conf = array(
‘site_name’ => ‘SITE NAME’,
‘theme_default’ => ‘THEME’,
‘site_frontpage’ => ‘node/X’,
‘anonymous’ => ‘Visitor’
)
wherein SITE NAME is said domain name, THEME is a definitional template, and X is a node reference automatically generated by said content management system.
